(19) United States
(12) Patent Application Publication
(10) Pub. No.: US 2006/0014524 A1
(43) Pub. Date: Jan. 19, 2006

(54) Communication system between a mobile terminal and a communication server and associated communication processes

(76) Inventors: Marc Leforestier, Baule (FR); Francois Rene, Paris (FR); Laurent Sevenier, Isdes (FR)

Correspondence Address: PERMAN & GREEN, 425 POST ROAD, FAIRFIELD, CT, 06824, US

(21) Appl. No.: 10/770,867

(22) Filed: Feb. 3, 2004

(30) Foreign Application Priority Data
Dec. 16, 2003 (FR) FR 0314767

(51) Int. Cl. H04L 12/58

(52) U.S. Cl. 455/412.1

(57) ABSTRACT

The present invention relates to a communication system including at least one client module built into a mobile terminal for distributing an encoded data item, a server module built into a communication server for retrieving the data coming from at least one existing external network and a communication network for transferring tho encoded data item between the client module and the server module, the data item being transmitted by sending a concatenated message including several segments at least one of the segments corresponding to a multi-character encoded command, the message being also able to include segments corresponding to variables required to execute the command and recursive variables that are placed at the head of the concatenation and may be an authentication number of the mobile terminal, the segments being terminated by a distinctive character indicating the segment end in the concatenation.

The present invention relates to a communication system between a mobile terminal and a communication server. The technical field of the invention is related to network communication by the transmission of an image, sound and text message between at least two communication means. The present invention relates more particularly to a fast and secure process for transmitting data between a mobile terminal and a communication server.

Wireless communication systems are known in the prior art that allow data to be transferred between transportable telephones (SMS, message handling system) or between a transportable telephone and a communication server (WAP) through communication networks, such as conventional networks belonging to telephone operators or to internet access providers or short-wave networks such as the WI-FI network. One of the drawbacks of these communications is the considerable time it takes to transfer data between for example a transportable telephone and a communication server. Another drawback is the lack of security while transferring data through the different networks.

The objective of the present invention is to overcome some drawbacks of the prior art, by proposing a communication system that offers fast and secure processes for communicating the data transiting between a mobile terminal and the communication server through different communication networks.

A first goal is achieved by a communication system allowing the transfer of at least one encoded data item between a mobile terminal and a communication server, said system including at least one client module built into the mobile terminal allowing the encoded data item to be distributed to a user of said mobile terminal, a server module built into the communication server allowing the data item coming from at least one existing external network to be retrieved and at least one communication network allowing the encoded data item to be transferred between the client module of the mobile terminal and the server module of the communication server, said communication system being characterised in that the data item is transmitted by sending a concatenated message including one or more segments, at least one of the segments corresponding to a four character encoded command, the message being also able to include segments corresponding to variables required to execute the command and recursive variables said recursive variables being placed at the head of the concatenation and being able to be an authentication number of the mobile terminal, the segments being terminated by a distinctive character indicating the segment end in the concatenation.

According to another embodiment, a concatenated message may be transmitted via two different networks, either a short-wave communication network, such as the WI-FI network, when the mobile terminal and the communication server are located in one and the same short-wave communication zone, or, in the contrary case, a conventional network such as the mobile radiotelephone network.

According to another embodiment, the client module built into the mobile terminal includes an automatic detection means making it possible to ascertain whether the mobile terminal is in a short-wave communication network.

According to another embodiment, the communication system includes a gateway module built into a terminal belonging for example to a conventional network operator, said gateway module allowing the encoded data item to be transferred between the server module of the communication server and the client module of the mobile terminal via the conventional network.

According to another embodiment, the client module, the server module and the gateway module include an internal engine able either to convert the encoded commands received by one or other of the modules into action, or to create a concatenated message encoded in a proprietary language to be sent to another communication system module, said internal engine including a main master engine ensuring the traffic of processing data and one or more secondary slave engines making it possible to execute the actions to be performed, said modules also including a library internal to the modules comprising a set of processes allowing actions related to the required commands to be executed.

According to another embodiment, the main engine of the internal engine includes a means of receiving a data item, a means of decoding a data item, a means of processing the message, a means of encoding a data item and a means of transmitting a data item, the decoding means including a means of detecting a subdivision of segments in a concatenation and a means of splitting the concatenation into segments, the encoding means including a means of creating a concatenated message.

According to another embodiment, the actions executed by the secondary engines of the internal engine may be an image display or a sound transmission.

According to another embodiment, the commands are encoded using a proprietary language of functionalities, a command being able to be composed of four characters, each command being unique and not being able to combine with another command.

According to another embodiment, the internal engine of the client module, the server module and the gateway module runs on a UNIX™ architectural base operating system such as Symbian®.

A second goal is achieved by a data transmission process performed by an internal engine of modules of a communication system, including at least a client module built into a mobile terminal, a server module built into a communication server and at least one communication network allowing encoded data item to be transferred between the client module and the server module, said data transmission process being characterised in that when a concatenated message is received by one of the modules, the process includes the following steps:

a step of reception of a data item in the form of a concatenated message, by the reception means of the main engine,

a step of detection of segments included in the concatenation and of splitting this concatenated message into several segments, said step being performed by the decoding means of the main engine.

a step of identification of the segment corresponding to the commands to be executed, by the decoding means of the main engine,

a step of searching by the processing means of the main engine for a process corresponding to a command, said process being placed in the internal library of the modules,

a step of initiation by the required process of actions by the secondary engine or engines,

and in that when a concatenated message is transmitted the process includes the following steps:

a step of reception of the data item stored in a storage means or transmitted by a user via a transmission means, said step being performed by the reception means of the main engine,

a step of encoding the command corresponding to the execution of said data item, by the encoding means of the main engine,

a step of creation of a concatenated message, including at least the encoded command and the data item to be transmitted, by the encoding means of the main engine,

a step of transmission of the concatenated message to another module of the communication system, by the transmission means of the main engine.

According to another embodiment, when an action is sent by the main engine to at least one secondary engine, the main engine waits for a response from the second engine, before sending another action.

Another goal is achieved by a communication process between a mobile terminal and a communication server according to a communication system, including at least a client module built into the mobile terminal, a server module built into the communication server and at least one communication network allowing encoded data item to be transferred between the client module and the server module, each module including an internal engine, said communication process being characterised in that the transmission of a data item from the communication server to the mobile terminal includes the following steps:

a step of reception and of encoding, by the server module of the communication server of a data item coming from an external network,

a step of verification of the presence of the mobile terminal on the communication system network,

a step of transmission of the encoded data item via the communication system network to the client module of a mobile terminal.

a step of reception and of decoding,

a step of distribution of the data item by the client module of the mobile terminal,

and in that the transmission of a data item from the mobile terminal to the communication server includes the following steps:

a step of encoding by the client module of the mobile terminal of a data item transmitted by a user, via a transmission means belonging to said mobile terminal, intended for the client module of a second mobile terminal or intended for the server module of the communication server,

a step of transmission of the encoded data item via the communication system network to the server module of the communication server, or to the client module of the second mobile terminal,

a step of reception and of storage, in a storage means of the communication server, of the encoded data item or of decoding and distribution of the data item by the client module of the second mobile terminal.

According to another embodiment, the step of verifying the presence of the mobile terminal on said network includes a step of transmission of an encoded message by the client module of the mobile terminal to the server module of the communication server informing the server module of the presence of the mobile terminal on the short-wave communication network, if the server module does not respond before the end of a standby step defined according to the lapse of a pre-set time the client module repeats the step of transmission of the encoded message.

According to another embodiment, the step of transmission of an encoded data item from the client module of a first mobile terminal transmitting said data item to the client module of a second mobile terminal recipient of said data item includes the following sub-steps:

transmission by the client module of the first mobile terminal to the server module of the communication server of a first encoded message asking the server module if the second mobile terminal recipient of the encoded data item is present on the short-wave communication network,

reception and decoding by the server module of the first encoded message and transmission of a second encoded message by the server module to the client module of the first mobile terminal, informing it of a response,

transmission of the encoded data item by the client module of the first terminal directly to the client module of the second mobile terminal, if said second mobile terminal is present on the short-wave communication network,

transmission of the encoded data item by the client module of the first terminal to the server module of the communication server and storage of the encoded data item by said server module, if the second mobile terminal is not present on the short-wave communication network.

According to another embodiment, the step of transmission of an encoded data item between the server module of the communication server and the client module of the mobile terminal is performed via the integrated gateway module and includes the following sub-steps:

transmission by the server module to the gateway module of a first encoded message requesting the setting up of a connection to the client module,

reception and decoding of the first encoded message by the gateway module, transmission of a second message by the gateway module to the terminal, for example of the conventional communication network operator, so as to set up the connection between the gateway module and the client module and standby by the gateway module for the presence of the mobile terminal on the conventional communication network,

transmission by the client module to the gateway module of a third encoded message informing of the presence of the mobile terminal on the conventional communication network, reception by the gateway module of the third encoded message.

transmission by the gateway module to the server Module of the third encoded message informing of the presence of the mobile terminal on the conventional communication network, reception and decoding by the server module of the fourth encoded message,

transmission by the server module to the gateway module of the encoded data item stored in the storage means of the communication server,

reception and transmission by the gateway module to the client module via the conventional communication network of the encoded data item.

Other particularities and advantages of the present invention will emerge more clearly from reading the description below, given with reference to the appended drawings, in which;

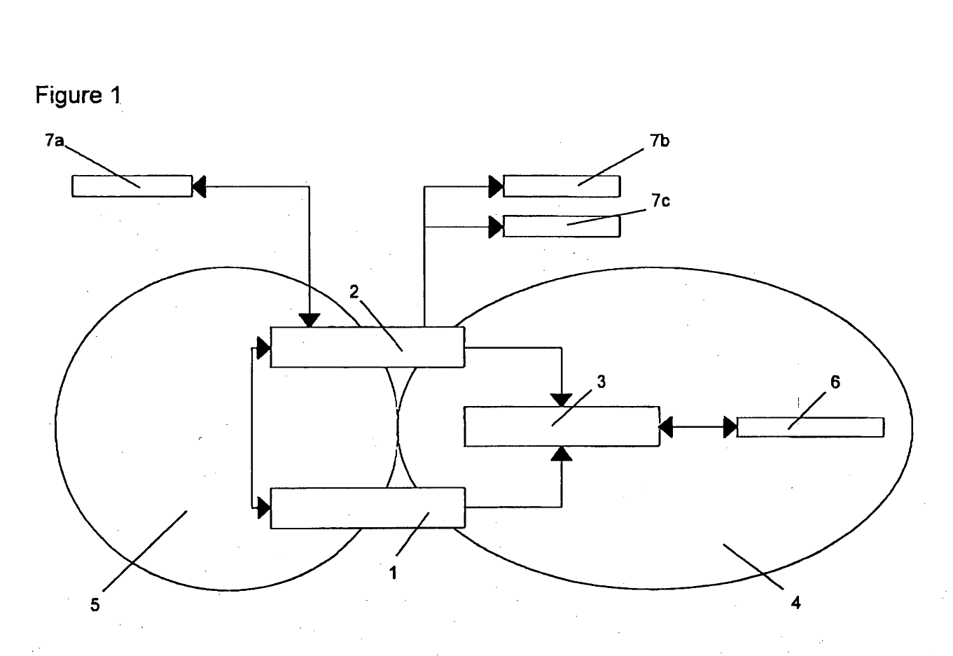

FIG. 1 shows a diagram representing the network architecture of the communication system according to one embodiment of the present invention;

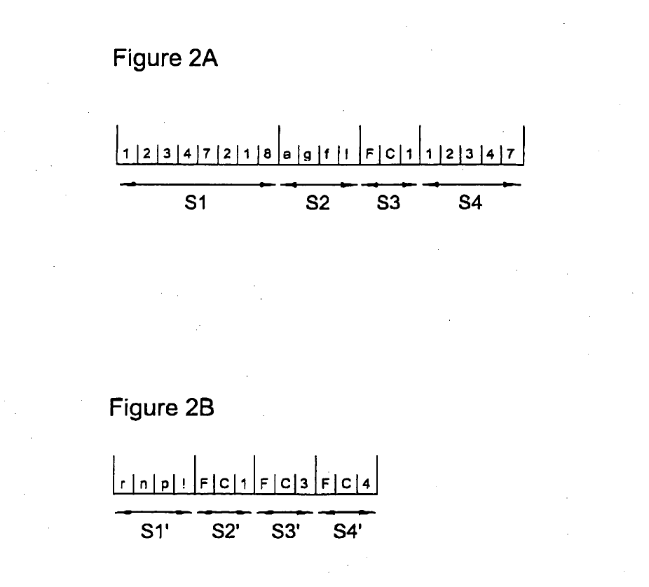

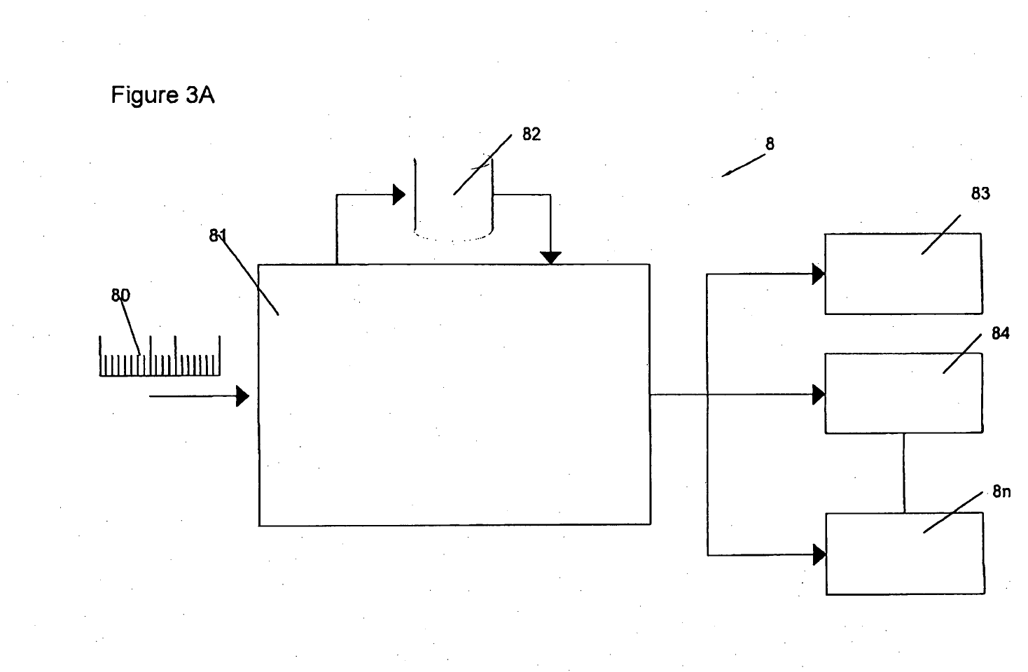

FIG. 2A shows a diagram representing a concatenated data item coming for example from a client module of a mobile terminal to a server module of a communication server, according to one embodiment of the present invention;

FIG. 2B shows a diagram representing a concatenated data item coming for example from a server module of a communication server to a client module of mobile terminal according to one embodiment of the present invention;

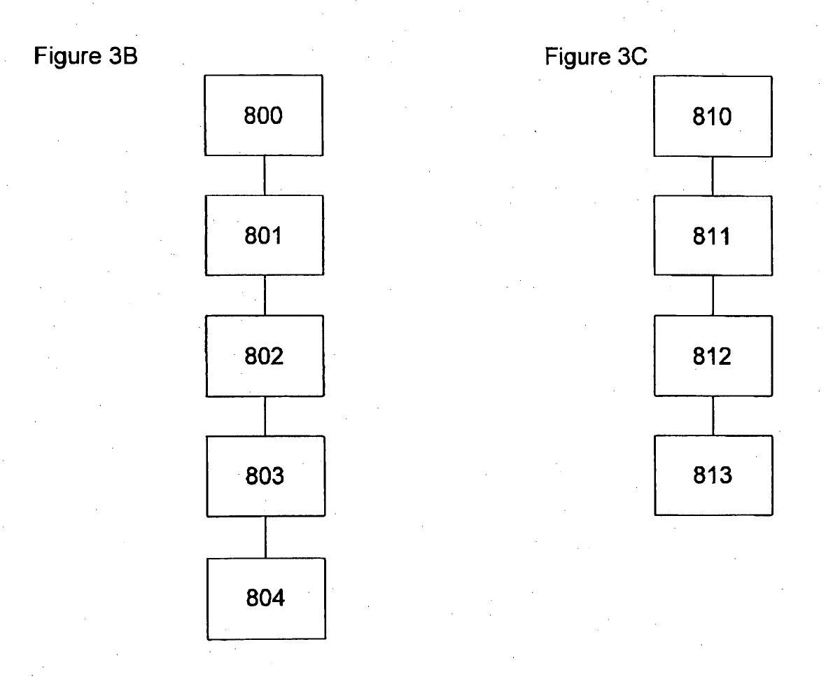

FIG. 3A shows a diagram representing an internal engine located in each of the modules belonging to the communication system according to one embodiment of the present invention;

FIG. 3B shows the block diagram representing the operating process of the internal engine of one of the communication system modules while receiving a concatenated data item, according to one embodiment of the present invention;

FIG. 3C shows the block diagram representing the operating process of the internal engine of each of the communication system modules during transmission of a concatenated data item, according to one embodiment of the invention;

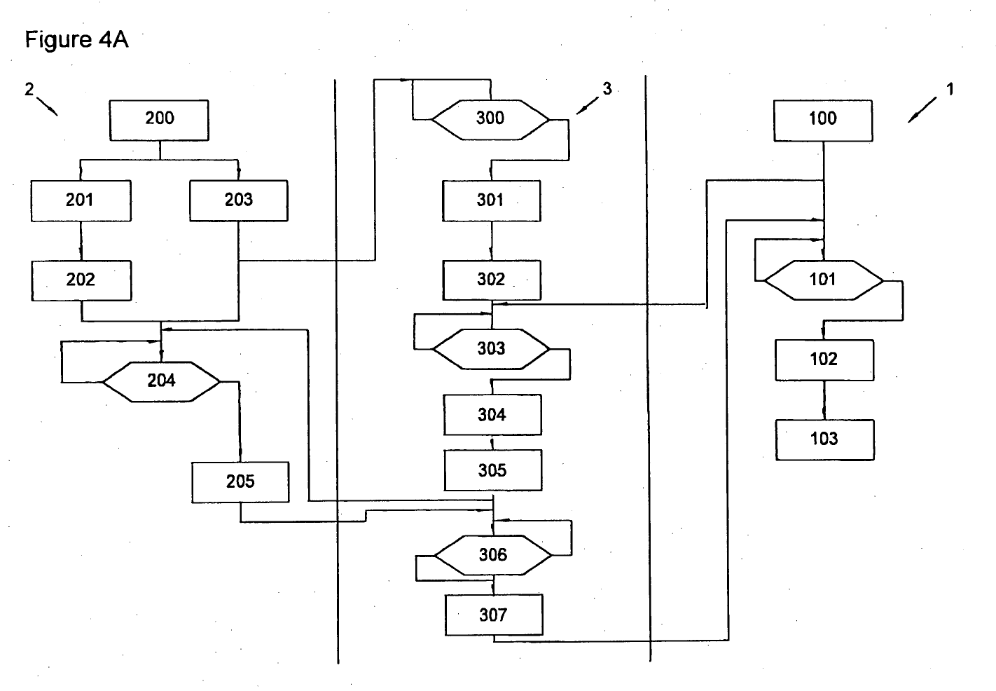

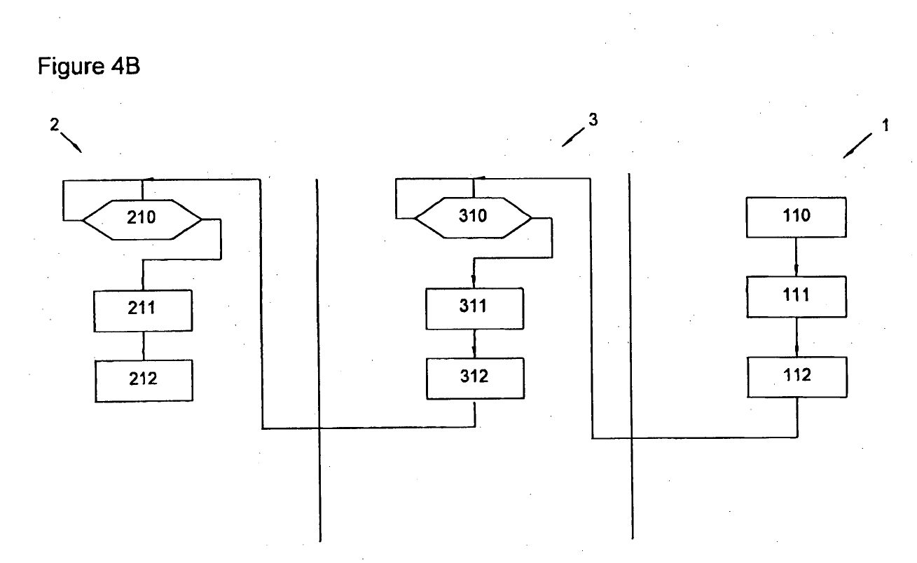

FIG. 4A shows the block diagram representing the process of transmitting data from a communication server to a mobile terminal via a conventional network of the mobile radiotelephone network type, according to one embodiment of the present invention;

FIG. 4B shows the block diagram representing the process of transmitting data from a mobile terminal to a communication server via a conventional network of the mobile radiotelephone network type, according to one embodiment of the present invention;

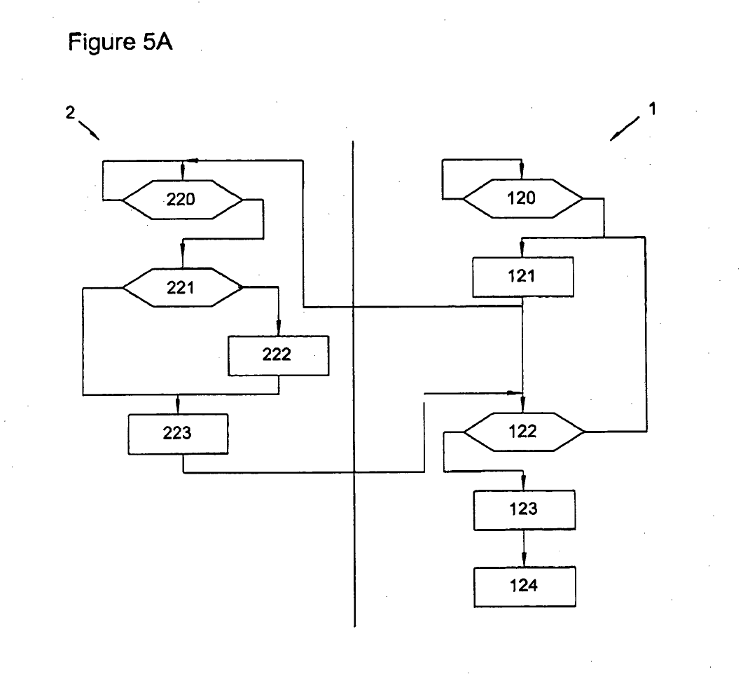

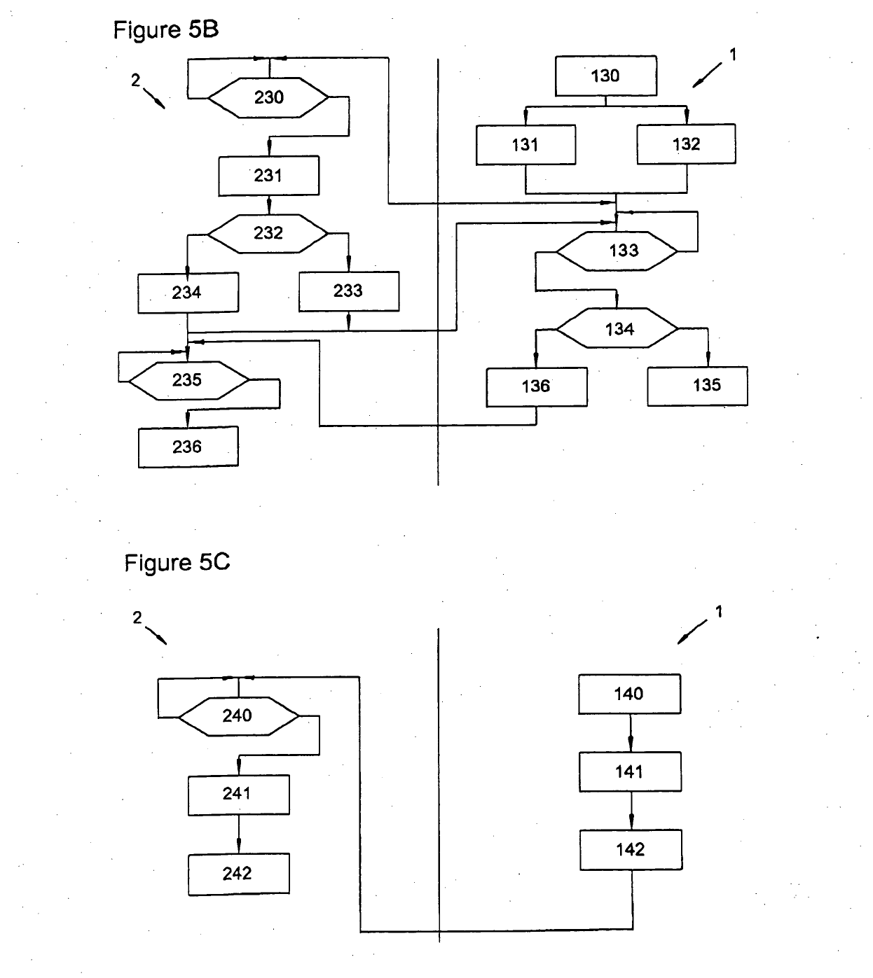

FIG. 5A shows the block diagram representing the process of transmitting data from a communication server to a mobile terminal via a short-wave network of the WI-FI type, according to one embodiment of the present invention;

FIG. 5B shows the block diagram representing the process of transmitting data from a mobile terminal to a communication server via a short-wave network of the WI-FI type, during data transmission between two mobile terminals for example, according to one embodiment of the present invention;

FIG. 5C shows the block diagram representing the process of transmitting data from a mobile terminal to a communication server via a short-wave network of the WI-FI type, during a transaction, such as remote shopping or remote voting by the mobile terminal user for example, according to one embodiment of the present invention.

The communication system of the present invention allows direct or indirect data transmission, for example by e-mail or instant messaging between two mobile communication terminals. It also allows to perform transactions, such as transmissions of commercial offers from a manufacturer or a telephone operator to a mobile terminal, remote shopping or remote electronic voting from a mobile terminal to a communication server.

FIG. 1 shows a diagram representing the general architecture of the communication system according to one embodiment of the present invention. The communication system of the present invention includes three modules (1, 2, 3) allowing data to be transferred between mobile terminals, for example a transportable telephone or a PDA type personal assistant and traditional communication servers, in other words devices that store and distribute data. Data can be transmitted within the communication system through two different networks (4, 5). A first network (4) is for conventional remote or long wave communication, for example a mobile radiotelephone network, in which the data passes through the network from a mobile telephony operator (6) or an Internet access provider. A second network (5) is for short-wave communication of the WI-FI type and/or of the Bluetooth type. Of these three modules (1, 2, 3) of the communication system presented above, a first module called client module (1) is built into the chip of a mobile terminal and/or onto any storage medium internal to the terminal. This client module (1) is the data emitting element of the communication system of the present invention to a mobile terminal user in the form of fixed or animated images, sound or text. Data passes in the client module (1) in accordance with several communication means, such as instant text messaging, electronic message transmission and receipt. The client module (1) includes an automatic detection means making it possible to identify whether the mobile terminal is on a short-wave network of the WI-FI type. A second module, called server module (2), is built into a communication server. This module (2) is the data distributing element of the communication system. The communication server is connected to other existing networks (7a, 7b, 7c) external to the network of the system of the present invention. These external networks (7a, 7b, 7c) are able to use communication protocols such as the SMS protocol (7b), the internet protocol (7c) or the protocol dedicated, for example, to a bank computer system (7a). The server manages communication flows, and may, for example, be connected to a bank network (7a) or to the internet network of a trader (not shown). The server module (2) allows data coming from one or more external networks to be encoded into a proprietary language for subsequent transferral of said encoded data through the communication system of the present invention. The proprietary language will be given in the remaining part of the description. The third module of the communication system is the gateway module (3). This module (3) is used during the communication via a conventional network (4), such as an operator's mobile radiotelephone network. The gateway module (3) is built into the terminals of telephone operators (6) or Internet access providers. It allows data to pass from the communication system of the present invention to a remote communication system via an operator network (6). When a telephone operator or a manufacturer needs to send data either to the client module (1) of the mobile terminal, or to the server module (2) of the communication server, he uses the gateway module (3) installed in his terminal. During a short-wave communication (5) of WI-FI type between a mobile terminal and a communication network, the gateway module (3) has no role to play, since the communication is effected directly between the client module (1) of the mobile terminal and the server module (2) of the communication server. In the preferred embodiment of the present invention it is the WI-FI and/or Bluetooth type short-wave network that will be used most often by the communication system. This network. (5) allows the data to be passed more rapidly with greater security.

Data is transmitted rapidly and securely between the different modules (1, 2, 3) of the communication system of the present invention by means of concatenated messages, one part of said message being encoded in a proprietary language. FIGS. 2A and 2B show a concatenated message according to one embodiment of the present invention. A concatenated message includes several segments including at least one segment corresponding to an encoded command (S2, S1′). The other segments of the message may comprise variable data (S3, S4, S2′, S3′, S4′) useful in executing the encoded command and recursive data (S1), for example identification data, such as a mobile telephone International Mobile Subscriber Identity (IMSI) number. The encoded command (S2, S1′) is composed of four characters. This coding uses a new proprietary language called in the remaining part of the description Frene language. This proprietary language is unique for reasons of speed and optimum compatibility. The vocabulary and the grammar used are new. A type of language used may be, for example, in respect of a “send” command composed of the three characters “r”-“n”-“p” followed by an argument symbol “!”. Each Frene language command is unique and can not be combined with another command. The different segments are spotted and easily divisible, using a subdivision means, for example a specific character located at the end of a segment. The position of the various segments varies according to whether specific segments are present or not and according to the module, of the communication system, sending the data item. Thus, when the segments comprising recursive data (S1) are present in the concatenation, they are placed at the message head thus allowing character concatenation processing to be speeded up. Again in the interests of speed the main elements also have a precise hierarchical organisation, For example, the first segment of the concatenation (S1), sent from the client module (1) of the mobile terminal to the other modules of the communication system, may include the calling IMSI number which is the mobile terminal manufacturer number. Likewise, the first segment (S1′) of the concatenation, sent from the server module (2) to the is client module (1), may include the command encoded in Frene.

FIG. 3A shows a block diagram representing an internal engine (8) operating in each of the three modules (1, 2, 3). The internal engine (8) is able to convert into action the encoded commands transmitted via a concatenated message (80) by another module. The internal engine (8) includes a main master engine (81) whose role is to provide the traffic of data for processing and one or more secondary slave engines (83, 84 to 8n) whose role is to perform actions relative to the commands sent. A library (82) internal to the module stores different processes corresponding to the actions to be performed. The main engine includes a means of receiving a concatenated or non-concatenated message, a means of decoding said concatenated message, a means of processing the different segments present in a concatenated data item, a means of encoding a new data item and a means of transmitting a data item. The decoding means comprises a means of detecting subdivisions of the different segments present in the concatenated data item, a means of splitting the concatenation into different segments, and a means of identifying the different segments, such as the segment corresponding to the command and those corresponding to the data. The encoding means comprises a means of creating a segment concatenation forming a concatenated data item.

FIG. 3B shows the block diagram of the internal engine (8) during reception of an encoded data item (80). This data item is transmitted via a concatenated message as described above comprising at least one command encoded in Frene language. When a concatenated data item arrives the main engine (81) performs the following steps:

a step of reception (800) of the data performed by a reception means of the main engine,

a step (801) of detection of the subdivisions defining the position of the segments in the concatenation and of splitting the concatenation, performed respectively by the subdivision detection and concatenation splitting means of the decoding means,

a step of spotting the segments (802) identifying a first segment (S2, S1′) including the encoded commands, the step being performed by the means of spotting the different segments of the decoding means of the main engine—each command corresponds to a precise process allowing actions to be initiated, all the processes being stored in the internal library (82) of the module-,

a step of searching (803) for the process or processes defined by the command or commands in the internal library (82) carried out by the decoding means,

a step of initiation (805) of the actions defined by the processes, said step being performed by the process operating means of the main engine.

The process operating means initiates actions in a precise order to the secondary engines (83, 84, to 8n) that will carry them out. These actions are for example the display of an image by a secondary graphical engine (83), the transmission of a sound by a secondary sound engine (84). The parameters and data necessary (S1, S3, S4, S2′, S3′, S4′) for the proper operation of these actions are also transmitted by the concatenated message as explained previously. The mode of transmitting data and actions between the main engine (81) and a secondary engine (83) is achieved by a question/answer system, in other words, when an action is transmitted, the main engine (81) will await a response from the secondary engine (83) before sending another action to the same secondary engine (83).

Likewise, FIG. 3C shows the block diagram of the internal engine (8) when an encoded data item is sent to another communication system module. A data item coming from a user via a transmission means, for example a terminal keypad, will be transmitted to the main engine (81) during a first step (810). Then the internal engine will perform the following steps:

a step of encoding the data item into Frene language, (811), performed by the encoding and concatenation creation moans of the main engine (81)—for example the response to a vote in case of a client module (1) of a mobile terminal,

a step of development of the concatenation (812) of the data item segments performed by the concatenation creation means of the encoding means, said segments comprising the encoding commands, and the data item for transmission,

a step of transmission of the concatenated data hem (813) performed by the transmission means of the main engine (81) allowing the concatenation to be sent to one of the two other communication system modules, for example the server module (2) of the communication server.

Each module is built preferably into a terminal having a UNIX™ architecture based operating system. For example, one of the preferred operating systems of the invention is Symbian®. The standard of this operating system is standardised by most manufacturers in transportable mobile terminals. Symbian® is capable of driving the different communication protocols such as Bluetooth and accepts C++ as basic language and the use of an additional graphical interface module containing, for example, a software engine that encapsulates a vector-based drawing language, such as Macromedia©® Inc's Flash™ Plug-in. This type of operating system may just as well be installed on an electronic chip processor and/or an internal storage means of the mobile terminal as on the terminal of a telephone operator or a manufacturer and also on the terminal of the communication server. Therefore it allows functions to be programmed directly through an authentic operating system.

In the remaining part of the description, the different data transmissions between the communication system modules and the networks are described.

FIG. 4A shows the block diagram of a communication for which the data item is sent by a communication server to a mobile terminal via a conventional telecommunications network, for example the mobile radiotelephone network. The data transmitted between the server module (2) and the client module (1) passes through the gateway module (3) built into the terminal of the telephone operator or of the internet access provider with whom the mobile telephone user has a communication contract. When a data item or items, such as data relating to a commercial offer or a message coming from an instant messaging service arrives from an external network to the server module (2), the internal engine of the server module performs the following steps:

a step of reception (200) of said non-encoded data, performed by the reception means of said internal engine,

a step of encoding (301) of said data into the Frene proprietary language performed by the encoding means of said internal engine,

a step of storage (302) of the encoded data in a storage means built into the communication server,

a step of creation of a concatenation of a first encoded message and of transmission (203) of said first encoded message to the gateway module (3), said step being performed at the same time as the two previous steps, and being respectively performed by the concatenation creation means and transmission means of said internal engine, said first message being sent to the gateway module (3) asking it to contact the client module (1) of the mobile terminal recipient of the encoded data via the telephone operator network (5), for example, and to set up a connection with this client module (1).

The internal engine of the gateway module (3) is in a standby state to receive a message (300), when the first encoded message arrives. On reception of said message, the internal engine of the gateway module (3) performs the following steps:

a step of reception and decoding (301) of the first encoded message sent by the server module (2), performed respectively by the reception means and the decoding means,

a step (302) informing the operator or the manufacturer concerned asking him to set up a connection with the mobile terminal recipient of the data item,

a step of waiting (303) for the presence of the mobile terminal on the operator network.

So long as the mobile terminal is not present on the network, the server module (2) keeps the encoded data for transmission stored in its storage, means. As soon as the mobile terminal user switches the terminal on, the internal engine of the client module (1) performs the following steps:

a step of creation and transmission (100) of a second encoded message to the operator informing him of the presence of the terminal mobile on the conventional network, said step being performed by the encoding means and transmission means respectively of the internal engine.

a step of waiting (101) for receipt of a data item.

As soon as the mobile terminal is present on the operator network, the internal engine of the gateway module (3) performs:

a step of reception (304) of the second encoded message, performed by the reception means of the internal engine, and

a step of transmission (305) of said second encoded message to the server module (2), performed by the transmission means of the internal engine.

Then, the internal engine of the server module (2) performs the following steps:

a step of reception and decoding (204) of the second encoded message, performed by the reception means and the decoding means of the internal engine,

a step of creation of the concatenation and of transmission (205) to the gateway module (3) of the encoded data item intended for the client module (1) of the mobile terminal, said step being performed respectively by the encoding means and the transmission means of the internal engine.

The gateway module (3) performs:

a step of reception (306) of the encoded data item, performed by the reception means of the internal engine,

a step of transferral of the data item (307) to the telephone operator and of transmission of the data item to the client modulo (1) of the mobile terminal, said step being performed by the transmission means of the internal engine.

The internal engine of the client module (1) performs the following steps:

a step of reception and decoding of the data item (102) by the reception means and decoding means of the internal engine,

a step of distribution (103) of said data item, controlled by one of the secondary engines, to the mobile terminal user in image, sound or text form.

FIG. 4B shows the system diagram of a communication for which the data item is sent by a mobile terminal to a communication server via a conventional telecommunication network. This diagram comprises several steps performed by the internal engine of the different communication system modules. The internal engine of the client module (1) of the mobile terminal performs the following steps:

a step of reception (110), by a reception means of said internal engine, of a data item transmitted by a mobile terminal user via, for example, a keypad, a touch screen or a sound process, said data item being intended for another mobile terminal,

a step of encoding (111) of said data item into Frene language, performed by the encoding means of said internal engine,

a step of creation of a concatenation and of transmission (112) of the encoded data item, performed respectively by the concatenation creation means and the transmission means of said internal engine, the encoded data item being sent to the gateway module (3) built into the terminal of a telephony operator or to his access provider with whom the user has a communication contract.

The internal engine of th gateway module (3) is in a standby state (310), when the encoded data item arrives. The reception means of the internal engine of the gateway module (3) then performs the following steps:

a step of reception of the encoded data item (311) by the reception means of the internal engine,

a step of transmission of the encoded data item (313) by the transmission means of the internal engine.

Then the internal engine of the server module (2) performs the following steps:

a step of reception (211) of the encoded data item by the reception means,

a step of storage (212) of said encoded data item by the storage means. This data item will then be, either transmitted to another mobile terminal, or processed if it is a question, for example, of a purchase or a remote electronic vote.

FIG. 5A shows the block diagram of a communication for which the data item is sent by a communication server to a mobile terminal via a WI-FI type short-wave network and/or Bluetooth. The internal engine of the client module (1) of the mobile terminal performs the first following steps:

a step of detection (180), via its automatic detection means, of the presence of the mobile terminal in a short-wave zone, for example WI-FI zone,

a step of transmission of an encoded message (21) to the server module (2) of the communication server, placed in the same WI-FI zone, said encoded message (121) indicating to the server module (2) that the mobile terminal is present in the WI-FI zone,

a standby step (122) during which a counting means of said internal engine counts the time elapsing between the transmission of said encoded message and a pre-set stored time, if the time is past and no response has been transmitted from the server module (2), the internal engine of the client module (1) re-starts the previous step (121) of transmitting an encoded message.

The internal engine of the server module (2) performs the following steps:

a step of reception and decoding of the encoded message (220), performed respectively by the reception means and the decoding means of the internal engine,

a step of detection (222) of an encoded data item, stored in the storage means of the server module (2), for transmission to the mobile terminal or of taking account of the arrival of a data item for encoding and for sending to the mobile terminal,

a step of encoding (223) of a data item into Frene language, if a data item arrives from an external network, via the encoding means of said internal engine,

a step of creation of a concatenation and of transmission of said encoded data item (224) to the client module (1) of the mobile terminal via the short-wave network, said step being performed respectively by the concatenation creation means and the transmission means of the internal engine.

Then the internal engine of the client module (1) performs the following steps:

a step of reception and decoding (123) of the encoded data item, by the reception means and the decoding means of said internal engine,

a step of distribution (124) of the data item controlled by one of the secondary engines of said internal engine.

FIG. 5B shows the block diagram for which the data item is sent by a mobile terminal to a communication server via a WI-FI type short-wave network, during the transmission of a data item from a mobile terminal that is transmitting or calling a recipient mobile terminal. A first user of a first mobile terminal sends a first message intended for a second user of a second terminal mobile terminal via the communication system of the present invention, in a step (130). The internal engine of the client module (1) of the first transmitting mobile terminal performs the following steps:

a step of encoding of the first message of the first user by a means of encoding and storing said message in the storage means of the mobile terminal (131),

a step of creation of a concatenation and of transmission (132) of a s second encoded message to the server module (2), performed simultaneously to the previous step (131), respectively by the concatenation means and the transmission means of said internal engine, in order to ascertain whether or not the second mobile terminal is present on the short-wave network,

a step (133) of putting the response of the server module (2) on standby.

The internal engine of the server module (2) is in a standby state (230), when the second encoded message arrives. The internal engine of the server module (2) then performs the following steps:

a step (231) of reception of the second encoded message by a means of receiving and decoding said message by a decoding means of the internal engine—the server module (2) knows if the second mobile terminal is present in the WI-FI zone, when the latter automatically sends it an encoded data item indicating its presence on the network, as explained previously-,

a step of becoming aware (232) of whether or not the second mobile terminal is present on the short-wave network, said data item being able to be stored in the storage means of the server module (2),

a step of transmission (233, 234 according to the response expected) of a third encoded message to the client module (1) of the first mobile terminal,

if the second mobile terminal is not present in the WI-FI zone, a step of awaiting (235) the reception of the first encoded message sent by the internal engine of the client module (1) of the first terminal.

The internal engine of the client module (1) in a standby state (233) performs the following steps as soon as the third encoded message arrives:

a step of reception and decoding (134) of the third encoded message by the reception and decoding means of said internal engine and of detection of the response given,

if the second mobile terminal is in fact in the WI-FI zone, a step of creating a concatenation and of transmitting (135) directly th first encoded message to the client module of the second mobile terminal by the concatenation creation and transmission means of said internal engine,

If the second mobile terminal is not present in the WI-FI zone, a step of transmitting (136) the first encoded message to the server module (2), by the transmission means.

Subsequent to the step (136), the internal engine of the server module (2) performs a reception step (236), performed by the reception means, and a first message storage step, performed by the storage means. This first message will then be transferred to the second recipient mobile terminal, either via the conventional telecommunications network as explained previously, or via the WI-FI network, when the second mobile terminal will indicate its presence in a WI-FI zone to the server module (2).

FIG. 5C shows the block diagram for which the data item is sent by a mobile terminal to a communication server via a WI-FI type short-wave network, for example of when remote shopping or voting. A mobile terminal user makes, for example, a purchase acceptance or vote response request, by means of a transmission means such as a keypad during the step (140). The internal engine of the client module (1) then performs the following steps:

a step of encoding (141) of the data item by an encoding means,

a step of creation of a concatenation and of transmission (142) of the data item, by the concatenation creation and transmission means, directly via the WI-FI network to the server module (2) of the communication server.

The internal engine of the server module (2) is in a standby state (240), when the encoded data item arrives. The internal engine then performs the following steps:

a step of reception (241) of the encoded data item,

a step of storage (242) of the encoded data item in a storage means. The server module (2), depending on the request made or the option selected, will process the data item.

Several communication functions are envisaged by the communication system of the present invention. These functions may be, for example, the reception by a mobile terminal of electronic messages sent by a communication server, the initiation of an instant messaging service by a mobile terminal, the transmission of a commercial offer by a communication server, remote shopping via a mobile terminal, remote voting via a mobile terminal or any other communication. These different communication functions use encoded data transmission according to the communication network selected, as is specified above and shown by FIGS. 4A, 4B, 5A, 5B, and 5C.

Some of these communication functions are described below. For a better understanding of the different functions no mention is made of the different technical means of the internal engine of each communication system module, when describing the communication functions. However these different means are taken as accepted, with reference to the description given above.

A first communication function is the transmission of an electronic message by a communication server to a computer terminal or to a mobile terminal according to the choice of message recipient. The reception means of the internal engine of the server module (2) receives a data item encoded in Frene language from another communication server, for example. The decoding means of said internal engine converts the data item into a compatible language and the transmission means of said internal engine transmits the converted data item to internet servers of the SMTP or POP3 type. These servers may, for example, belong to access providers holding the e-mail accounts of the recipient of the encoded data item, when said recipient wishes to pick up the message from his personal computer. If the recipient wishes to receive the message on his mobile terminal, the client module (1) of the mobile terminal makes this request to the server module (2) of the communication server. The reception means of the internal engine of the server module transfers the data item from the e-mail server of the provider holding the e-mail account. The encoding means of the internal engine of the server module recodes the data item in Frene language and the transmission means of said internal engine sends the encoded data item back to the client module (1) of the mobile terminal receiving the electronic mall.

Another communication function relates to the initiation of the instant messaging service by a mobile terminal user. The instant messaging service using the Inter Relay Chat (IRC) protocol will only be active if the mobile terminal WI-FI zone detection means detects that it is inca short-wave zone. The encoding and transmission means of the internal engine of the client module (1) of the mobile terminal allow an encoded message to be transmitted in Frene language to the server module (2) so as to declare the client module (1) as being active. The reception means and the decoding means of the internal engine of the server module (2) respectively receives the data item and decodes it. The encoding and transmission means of the internal engine of the server module transmit a data item encoded in Frene language to the client module (1), indicating the statuses, connected or unconnected, of all the people is in the library of friends present on the WI-FI network.

Another communication function is the transmission by the communication server of data relating to commercial offers to the client module (1) of a mobile terminal. The server module (2) stores all the commercial offers in its storage means. When the mobile terminal is not in an area covered, for example, by the WI-FI network and when a user switches on his mobile terminal, the encoding and transmission means of the internal engine of the client module (1) of said mobile terminal allow an encoded request to be sent in Frene language to the gateway module (3) of a telephone operator for example, indicating to him the activation of the client module (1). The technical means of the internal engine of the gateway module (3) allow the client module request to be received and said request to be transmitted to the server module (2). The activation message may include the IMSI code and a concatenation of characters of the last package of commercial offers available in the memory of the client module (1). The processing means of the internal engine of the server module (2) compares the concatenation of characters of the last package with that which is present in the communication server memory. If the 2 codes are identical on comparison, the internal engine of the server module (2) sends nothing. If the 2 codes are different on comparison, the encoding and transmission means of the internal engine of the server module (2) sends back the latest commercial offer package in Frene language via the gateway module (3) of the operator who will route it to the client module (1) of the recipient mobile terminal. If the user is in a WI-FI short-wave zone, the data is exchanged directly between the client module (1) and the server module (2).

Another communication function relates to micro-payments for purchases or services via the telephone bill of the operator with whom the mobile terminal user has a communication contract. By default, the processing means of the internal engine of the client module (1) of the mobile terminal knows that the payment function does not operate on the WI-FI short-wave network. A first step of this function consists in transmitting by the encoding means and the transmission means of the internal engine of the client module (1), for example in relation to purchasing a commercial offer, a data item authorising the purchase, via the “I buy” command encoded in Frene language. The processing means of the internal engine of the gateway module (3) interacts with the operator's computer system so as to inform it that the user wishes to pay a sum corresponding to the amount validated at the time of his purchase and wishes to add this sum to his telephone bill. Thus, it is the telephone operator who pays for the purchase directly to a trader, the sum being then added to the telephone bill. The operator's computer system authorises or does not authorise the operation, for example, when the mobile telephone user has a debit balance. The computer system sends its response to the gateway module (3). This latter transmits via the encoding and transmission means of its internal engine, to the client module (1), the validity of the data encoded in Frene. If authorisation is given, the client module (1) sends, via the encoding and transmission moans of its internal engine, all purchase-related data in Frene language to the gateway module (3). This data can, for example, be the commercial offer code, a delivery address different from its invoicing address declared to the operator. The gateway module (3) sends, via the encoding and transmission means of its internal engine, the data encoded in Frene language to the server module (2) which processes the data with the trader, via the processing means of its internal engine.

The purchase payment function may also operate from a bank terminal, such as a bank ATM via the conventional network or the short-wave network. The user chooses, for example, a commercial offer on his mobile terminal via the client module (1) and selects the method of payment via a bank ATM. The encoding means of the internal engine of the client module (1) encodes in Frene language a comprehensive data item including, for example, the commercial offer code, a different delivery address or other data. When the data is transmitted via a telephone network, the transmission means of the internal engine of the client module (1) sends the encoded data to the gateway module (3). The transmission means of the internal engine of the gateway module sends said data to the server module (2). If the user is in a WI-FI short-wave zone, the exchange occurs directly between the client module (1) and the server module (2). The internal engine of the latter module stores it in a storage means while awaiting payment. The customer then presents himself at a bank ATM in order to pay for his purchase. Having identified the required payment method, the bank ATM offers the customer a payment-specific entry screen for the customer to enter his mobile terminal number, for example the IMSI number. Once the mobile number has been validated, the computer system of the bank asks the server module (2) to find out the amount of the transaction. The transmission means of the internal engine of the server module (2) sends in the language specific to the bank computer system, the exact amount to debit. The bank computer system manages the request and gives or refuses its authorisation sending the payment slip back to the server module (2). The payment slip, together with any data relating to the order processing are returned by the transmission means of the internal engine of the server module (2) to the trader. In order to confirm payment to the customer, the transmission means of the internal engine of the server module (2) sends him an SMS, via an external SMS server, showing him that his order has been validated and processed. The transmission means of the internal engine of the server module (2) sends a second SMS showing the customer the invoice number and the carrier selected, so that he is able to follow the stages in the delivery of his purchase on-line on the sites of the carrier companies providing the service.

Another payment function is payment by telephone. When a mobile terminal user has selected a commercial offer and payment method, the encoding and transmission means of the internal engine of the client module (1) of the mobile telephone send the data item encoded in Frene language to the gateway module (3) installed with a telephone operator. The transmission means of the internal engine of the gateway module (3) sends the encoded data item to the server module (2). If the user has access to the WI-FI network, the encoding and transmission means of the internal engine of the client module (1) sends the data item directly in encoded language to the server module (2). This latter stores the data item in its storage means. The user, via the client module (1), selects the payment function by telephone. He informs the telephone server by giving it a code, for example with 4 figures, via his telephone keypad. The telephone server sends said code to the server module (2) which verifies via the treatment processing means of its internal engine whether the code corresponds to a mobile telephone authentication number for example its IMSI number. If the comparison is not correct, the operation is denied and the encoding and transmission means of the internal engine of the server module (2) send a data item to the telephone server, which delivers an audio transaction denied message. If the comparison is correct, the processing means of the internal engine of the server module (2) triggers bank interrogation to obtain authorisation. The bank operator computer system gives or denies its authorisation. To confirm to the customer that the bank authorises the transaction, the transmission means of the internal engine of the server module (2) sends to the telephone server confirmation of order validation. The telephone server delivers an audio message to the customer of the “your order has been authorised” type. Simultaneously, the transmission means of the internal engine of the server module (2) sends the payment slip, together with any data relating to the order processing, to the trader. The transmission means of the internal engine of the server module (2) also sends an order confirmation SMS to the end customer showing him that his order has been validated and processed. The transmission means of the internal engine of the server module (2) sends a second SMS showing the customer the invoice number and the carrier selected, so that he can follow the stages in the delivery of his purchase on-line at the sites of the carrier companies providing the service.

Another preferred communication function of the invention is electronic voting via the mobile terminal. The encoding and transmission means of the internal engine of the server module (2), encodes in Frene language and sends a data item respectively, relating to a voting questionnaire, to the gateway module (3) or directly to the client module (1) according to the communication network present. Via the conventional network, the transmission means of the internal engine of the gateway module (3) sends the encoded data item to the customer module (1). The mobile terminal user responds to the question or questions posed through his terminal. Once the vote is validated, the encoding means of the internal engine of the client module (1) encodes the vote in Frene language and the transmission means of said internal engine sends the data to the gateway module (3), which transmits the encoded data to the server module (2). Once the data is received, the processing means of the internal engine of the server module (2) stores it and blocks the authentication number of the user who has just voted so that he/she can only vote once. Simultaneously, the processing means of the internal engine of the client module (1) deletes the vote from its memory. The processing means of the internal engine of the server module (2) redistributes the data to the computer system of the requester, in the computer language of the vote requestor system. If the user is in a WI-FI short-wave zone, the exchange occurs directly between the client module (1) and the server module (2).

Another preferred communication function of the invention is the downloading of pre-programmed service offerings, such as software, games, sound files, video, images and others. The processing means of the internal engine of the client module (1) of the mobile terminal selects service offerings for downloading and the encoding and transmission means of its internal, engine sends a message in Frene language requesting the gateway module (3) to transfer the downloaded service offerings. The gateway module (3) relays the request to the server module (2) in the encoded Frene language. The internal engine of the server module transmits the service offerings requested to the internal engine of the gateway module (3). This latter sends the data to the internal engine of the client module (1) in encoded language. If the user is in a WI-FI short-wave-zone, the exchange occurs directly between the client module (1) and the server module (2).

In the remaining part of the description one of the communication functions of the system of the present invention is presented in a more detailed way thus allowing better comprehension of the different data transmission steps between a communication server and a mobile terminal. In the instant messaging operating mode, all interactions between the client module (1) of a communication terminal and the server module (2) of a communication server is carried out via a WI-FI type short-wave network or Bluetooth, and is transmitted in Frene language. A mobile terminal user located in a WI-FI zone, for example, triggers the instant messaging service on the client module (1) of the mobile terminal so as to communicate with other instant messaging service users. The memory of the chip and/or a unit of storage of the transmitting mobile terminal includes a list comprising the different user authentication numbers belonging to the instant messaging service of the calling mobile terminal. To each authentication number corresponds a specific position in the list. These authentication numbers may correspond, for example, to the International Mobile Subscriber Identity (IMSI) number, representing a mobile manufacturer number. The encoding means of the internal engine of the client module (1) of the mobile terminal creates an encoded phrase segmented in Frene language, as shown in FIG. 2A, for sending to the server module (2) of the communication server. The encoded phrase includes a first segment (S1) comprising the authentication number of the calling mobile terminal, in the event the terminal on which the instant messaging service is initiated. The second segment (S2) represents a command, encoded in Frene language, which has to be carried out by the processing means of the internal engine of the server module (2). The following segments include for each user belonging to the library of friends, a position code on the mobile terminal list of a user to call (S3), followed by the authentication number of this user (S4). The second segment (S2) of the concatenation includes the command encoded in four characters thus showing the concatenation splitting means of the internal engine of the server module (2) to split the list, to subdivide the segments so as to find the numbers identifying instant messaging service users (S4) present on its list. Once the concatenation is created, the transmission means of the internal engine of the client module (1) sends it to the server module (2), Via the WI-FI network for example. The reception means of the internal engine of the server module receives the message, the decoding means of its internal engine splits the message and analyses first the second segment (S2) representing the command. The processing means of the internal engine of the server module (2) retrieves and then stores in its storage means, the number of the calling mobile terminal (S1), it then breaks up each segment (S3-S4) according to the subdivision defined by the command of the second segment (S2). The processing means of the internal engine of the server module (2) then takes each segment (S3, S4) and analyses then one after the other to find out if the user corresponding to the authentication number (S4) is present on the WI-FI network. At the end of the analysis, the processing means of the internal engine of the server module (2) compiles a new list containing only the position codes corresponding to the mobile terminal list of users to call present on the WI-FI network. The encoding means of the internal engine of the server module (2) creates a new concatenation, as shown in FIG. 2B, including as first segment the encoding command (S1′) asking the client module (1) of the calling mobile terminal to distribute the list present in the following segments (S2′ S3′ S4′). Having retained the authentication number of the calling mobile terminal (S1), the transmission means of the internal engine of the server module (2) sends it its new recompiled list. The processing means of the internal engine of the client module (1) of the calling mobile terminal displays the list and compares it with its own so as to identify the users present on the WI-FI network. In parallel, the processing means of the internal engine of the server module (2) retains in its memory the original concatenation sent by the client module (1), thus allowing it to detect and to compare on a permanent basis the users to call present on the short-wave network and to send back via the transmission means a recompiled concatenation each time there is a modification to tho list. As soon as the user stops using tho instant messaging service, the client module (1) of the mobile terminal concerned informs the server module (2) thereof. The processing means of this latter's internal engine deletes the original concatenation. These different steps occur during any communication between the different system modules, such as data downloading, paying for purchases, remote voting and the like.

It must be obvious for those skilled in the art that the present invention allows embodiments in many other specific forms without distancing it from the field of application of the invention as claimed. Consequently the present embodiments must be considered as illustrative, but can be modified in the field defined by the scope of the appended claims, and the invention must not be restricted to the details given above.

1. Communication system allowing the transfer of at least one encoded data item between a mobile terminal and a communication server, said system including at least one client module built into the mobile terminal allowing the encoded data item to be distributed to a user of said mobile terminal, a server module built into the communication server allowing the data item coming from at least one existing external network to be retrieved and at least one communication network allowing the encoded data item to be transferred between the client module of the mobile terminal and the server module of the communication server, said communication system being characterised in that the data item is transmitted by sending a concatenated message including one or more segments, at least one of the segments corresponding to a four character encoded command, the message being also able to include segments corresponding to variables required to execute the command and recursive variables said recursive variables being placed at the head of the concatenation and being able to be an authentication number of the mobile terminal, the segments being terminated by a distinctive character indicating the segment end in the concatenation.

2. Communication system, according to claim 1, characterised in that a concatenated message may be transmitted via two different networks, either a short-wave communication network, such as the WI-FI network, when the mobile terminal and the communication server are located in one and the same short-wave communication zone, or, in the contrary case, a conventional network such as the mobile radiotelephone network.

3. Communication system, according to claim 1, characterised in that the client module built into the mobile terminal includes an automatic detection means making it possible to ascertain whether the mobile terminal is in a short-wave communication network.

4. Communication system, according to one claim 1, characterised in that it includes a gateway module built into a terminal belonging for example to a conventional network operator, said gateway module allowing the encoded data item to be transferred between the server module of the communication server and the client module of the mobile terminal via the conventional network.

5. Communication system, according to claim 1, characterised in that the client module, the server module and the gateway module include an internal engine able either to convert the encoded commands received by one or other of the modules into action, or to create a concatenated message encoded in a proprietary language to be sent to another communication system module, said internal engine including a main master engine ensuring the traffic of processing data and one or more secondary slave engines making it possible to execute the actions to be performed, said modules also including a library internal to the modules comprising a set of processes allowing actions related to the required commands to be executed.

6. Communication system, according to claim 1, characterised in that the main engine of the internal engine includes a means of receiving a data item, a means of decoding a data item, a means of processing the message, a means of encoding a data item and a means of transmitting a data item, the decoding means including a means of detecting a subdivision of segments in a concatenation and a means of splitting the concatenation into segments, the encoding means including a means of creating a concatenated message.

7. Communication system, according to claim 1, characterised in that the actions executed by the secondary engines of the internal engine may be an image display or a sound transmission.

8. Communication system, according to claim 1, characterised if that the commands are encoded using a proprietary language of functionalities a command being able to be composed of four characters, each command being unique and not being able to combine with another command.

9. Communication system, according to claim 1, characterised in that the internal engine of the client module, the server module and the gateway module runs on a UNIX™ architectural base operating system such as Symbian®.

10. Data transmission process performed by an internal engine of modules of a communication system, including at least a client module built into a mobile terminal, a server module built into a communication server and at least one communication network allowing encoded data item to be transferred between the client module and the server module, said data transmission process being characterised in that when a concatenated message is received by one of the modules, the process includes the following steps:
a step of reception of a data item in the form of a concatenated message, by the reception means of the main engine.
a step of detection of segments included in the concatenation and of splitting this concatenated message into several segments, said step being performed by the decoding means of the main engine.
a step of identification of the segment corresponding to the commands to be executed, by the decoding means of the main engine,
a step of searching by the processing means of the main engine for a process corresponding to a command, said process being placed in the internal library of the modules.
a step of initiation by the required process of actions by the secondary engine or engines, and in that when a concatenated message is transmitted the process includes the following steps:
a step of reception of the data item stored in a storage means or transmitted by a user via a transmission means, said step being performed by the reception means of the main engine,
a step of encoding the command corresponding to the execution of said data item, by the encoding means of the main engine,
a step of creation of a concatenated message, including at least the encoded command and the data item to be transmitted, by the encoding means of the main engine,
a step of transmission of the concatenated message to another module of the communication system, by the transmission means of the main engine.

11. Data transmission process performed by the internal engine according to claim 10, characterised in that when an action is sent by the main engine to at least one secondary engine, the main engine waits for a response from the second engine, before sending another action.

12. Communication process between a mobile terminal and a communication server according to a communication system, including at least a client module built into the mobile terminal, a server module built into the communication server and at least one communication network allowing encoded data item to be transferred between the client module and the server module, each module including an internal engine, said communication process being characterised in that the transmission of a data item from the communication server to the mobile terminal includes the following steps:
a step of reception and of encoding, by the server module of the communication server, of a data item coming from an external network,
a step of verification of the presence of the mobile terminal on the communication system network,
a step of transmission of the encoded data item via the communication system network to the client module of a mobile terminal,
a step of reception and of decoding,
a step of distribution of the data item by the client module of the mobile terminal,
and in that the transmission of a data item from the mobile terminal to the communication server includes the following steps:
a step of encoding by the client module of the mobile terminal of a data item transmitted by a user, via a transmission means belonging to said mobile terminal, intended for the client module of a second mobile terminal or intended for the server module of the communication server,
a step of transmission of the encoded data item via the communication system network to the server module of the communication server, or to the client module of the second mobile terminal,
a step of reception and of storage, in a storage means of the communication server, of the encoded data item or of decoding and distribution of the data item by the client module of the second mobile terminal.

13. Communication process between the mobile terminal and the communication server according to claim 12. via a short-wave communication network, characterised in that the step of verifying the presence of the mobile terminal on said network includes a step of transmission of an encoded message by the client module of the mobile terminal to the server module of the communication server informing the server module of the presence of the mobile terminal on the short-wave communication network, if the server module does not respond before the end of a standby step defined according to the lapse of a pre-set time, the client module repeats the stop of transmission of the encoded message.

14. Communication process between the mobile terminal and the communication server according to claim 12, via a short-wave communication network, characterised in that the stop of transmission of an encoded data item from the client module of a first mobile terminal transmitting said data item to the client module of a second mobile terminal recipient of said data item includes the following sub-steps:
transmission by the client module of the first mobile terminal to the server module of the communication server of a first encoded message asking the server module if the second mobile terminal recipient of the encoded data item is present on the short-wave communication network,
reception and decoding by the server module of the first encoded message and transmission of a second encoded message by the server module to the client module of the first mobile terminal, informing it of a response,
transmission of the encoded data item by the client module of the first terminal directly to the client module of the second mobile terminal, if said second mobile terminal is present on the short-wave communication network,
transmission of the encoded data item by the client module of the first terminal to the server module of the communication server and storage of the encoded data item by said server module, if the second mobile terminal is not present on the short-wave communication network.

15. Communication process between the mobile terminal and the communication server according to claim 12, via a conventional communication network, characterised in that the step of transmission of an encoded data item between the server module of the communication server and the client module of the mobile terminal is performed via the integrated gateway module and includes the following sub-steps:
transmission by the server module to the gateway module of a first encoded message requesting the setting up of a connection to the client module,
reception and decoding of the first encoded message by the gateway module, transmission of a second message by the gateway module to the terminal, for example of the conventional communication network operator so as to set up the connection between the gateway module and the client module and standby by the gateway module for the presence of the mobile terminal on the conventional communication network,
transmission by the client module to the gateway module of a third encoded message informing of the presence of the mobile terminal on the conventional communication network, reception by the gateway module of the third encoded message,
transmission by the gateway module to the server module of the third encoded message informing of the presence of the mobile terminal on the conventional communication network, reception and decoding by the server module of the fourth encoded message,
transmission by the server module to the gateway module of the encoded data item stored in the storage means of the communication server,
reception and transmission by the gateway module to the client module via the conventional communication network of the encoded data item.
